(19) United States
(12) Patent Application Publication
(10) Pub. No.: US 2011/0289462 A1
(43) Pub. Date: Nov. 24, 2011

(54) Computing Device Magnification Gesture

(75) Inventors: Jonathan R. Harris, Redmond, WA (US); Andrew S. Allen, Seattle, WA (US)

(73) Assignee: MICROSOFT CORPORATION, Redmond, WA (US)

(21) Appl. No.: 12/784,146

(22) Filed: May 20, 2010

(51) Int. Cl. G06F 3/01; G06F 3/033; G06F 3/041

(52) U.S. Cl. 715/863; 345/173; 345/179

(57) ABSTRACT

Computing device magnification gesture techniques are described. In implementations, a first input is recognized as a magnification gesture to initiate magnification of at least a portion of a user interface displayed by a display device of a computing device. The magnified portion is displayed in the user interface as at least partially encompassed by an unmagnified portion of the user interface. A second input is recognized as specifying a modification to be made to data included in the magnified portion of the user interface, the second input recognized as occurring during provision of the first input. Responsive to recognition that the first input is no longer being provided, the display of the magnified portion ceases in the user interface.

### BACKGROUND

Mobile devices (e.g., wireless phones, portable game devices, personal digital assistants, tablet computers, and so on) have become an integral part of everyday life. However, the form factor employed by conventional mobile devices is typically limited to promote mobility of the mobile device.

Accordingly, the mobile communications device may have a relatively limited amount of display area when compared to a conventional desktop computer, e.g., a PC. Therefore, conventional techniques used to interact with a desktop computer may be inefficient when employed by a mobile device. For example, traditional techniques that were used to organize and view a user interface may be inefficient when utilized by a mobile device having a limited display area.

### SUMMARY

Computing device magnification gesture techniques are described. In implementations, a first input is recognized as a magnification gesture to initiate magnification of at least a portion of a user interface displayed by a display device of a computing device. The magnified portion is displayed in the user interface as at least partially encompassed by an unmagnified portion of the user interface. A second input is recognized as specifying a modification to be made to data included in the magnified portion of the user interface, the second input recognized as occurring during provision of the first input. Responsive to recognition that the first input is no longer being provided, the display of the magnified portion ceases in the user interface.

In implementations, a first input is recognized as selecting two points in a user interface displayed by a display device of a computing device and involving subsequent movement away from the two points. A magnification gesture is identified from the recognized first input, the magnification gesture effective to cause a magnified display of at least a portion of the user interface that corresponds to the selected two points, the magnified display at least partially encompassed by an unmagnified portion of the user interface. A second input is recognized as specifying interaction with data included in the magnified portion of the user interface, the second input recognized as provided during provision of the first input.

In implementations, one or more computer-readable media comprise instructions stored thereon that, responsive to execution on a computing device, causes the computing device to perform operations comprising: recognizing a touch input as a magnification gesture to indicate magnification of at least a portion of a user interface displayed by a display device of a computing device; displaying the magnified portion in the user interface as at least partially encompassed by an unmagnified portion of the user interface; recognizing a stylus input as specifying a modification to be made to data included in the magnified portion, the stylus input recognized as being provided during provision of the touch input; and responsive to recognition that the first input is no longer being provided, ceasing the displaying of the magnified portion in the user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ magnification gesture techniques described herein.

FIG. 2 is an illustration of a system in an example implementation in which a magnification gesture is recognized as being initiated to cause display of a portion of a user interface to be magnified.

FIG. 3 is an illustration of a system in an example implementation in which a magnification gesture of FIG. 2 is leveraged to modify data that is being magnified.

FIG. 4 is an illustration of a system in an example implementation in which an object that is selected via a magnification gesture is magnified.

FIG. 5 is a flow diagram depicting a procedure in an example implementation in which a magnification gesture is recognized to magnify a portion of a user interface and cease display of the magnification once the gesture is no longer detected.

FIG. 6 illustrates various components of an example device that can be implemented as any type of portable and/or computer device as described with reference to FIGS. 1-4 to implement embodiments of the magnification gesture techniques described herein.

### DETAILED DESCRIPTION

### Overview

Computing devices may be configured in a variety of different ways, such as for non-mobile and mobile uses. However, the form factor employed by conventional mobile devices is typically limited to promote mobility of the mobile device. Therefore, conventional techniques used to interact with a desktop computer may be inefficient when confronted with a limited amount of display area of typical display devices utilized by mobile devices.

Computing device magnification techniques are described. In implementations, the computing device is configured to recognize initiation of a magnification gesture, such as from two fingers of a user's hand being applied to display device and moved away from each other. The magnification gesture may then cause a magnified display in the user interface as a “virtual loupe” to view data in greater detail. Further, this display may be surrounded by unmagnified portions of the user interface.

A user may then interact with the magnified data, such as to modify the data using written inputs from a stylus. Once the user has completed the desired modifications, the user's fingers may be removed from the display device thereby causing the virtual loupe to “snap back” to show an unmagnified view. Further discussion of the magnification techniques may be found in relation to the following sections.

In the following discussion, an example environment is first described that is operable to employ the magnification gesture techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

### Example Environment

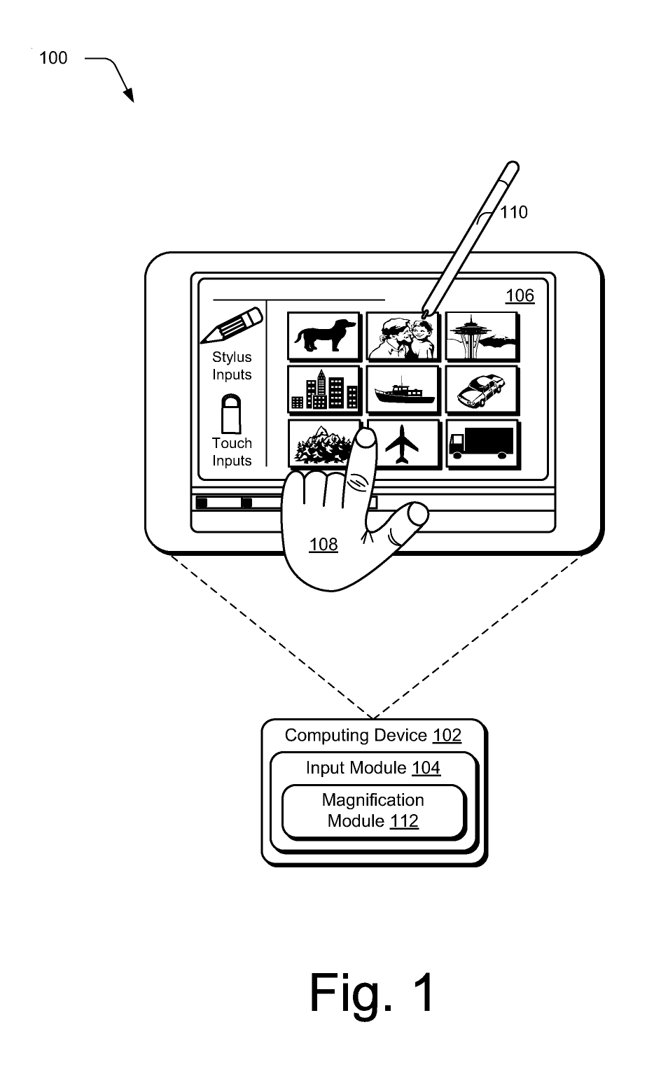

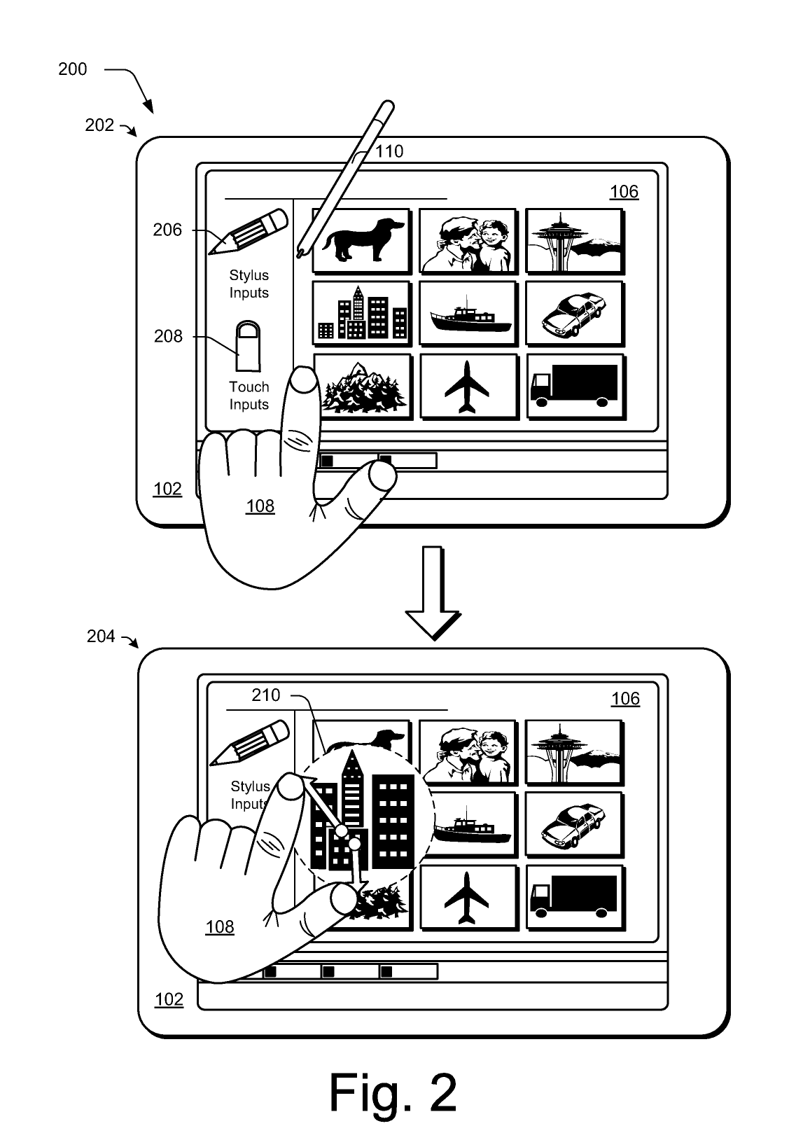

FIG. 1 is an illustration of an environment 100 in an example implementation that is operable to employ magnification gesture techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input module 104. The input module 104 is representative of functionality relating to inputs of the computing device 102. For example, the input module 104 may be configured to receive inputs from a keyboard, mouse, to identify gestures and cause operations to be performed that correspond to the gestures, and so on. The inputs may be identified by the input module 104 in a variety of different ways.

For example, the input module 104 may be configured to recognize an input received via touchscreen functionality of a display device 106, such as a finger of a user's hand 108 as proximal to the display device 106 of the computing device 102, from a stylus 110, and so on. The input may take a variety of different forms, such as to recognize movement of the stylus 110 and/or a finger of the user's hand 108 across the display device 106, such as a tap, drawing of a line, and so on. In implementations, these inputs may be recognized as gestures.

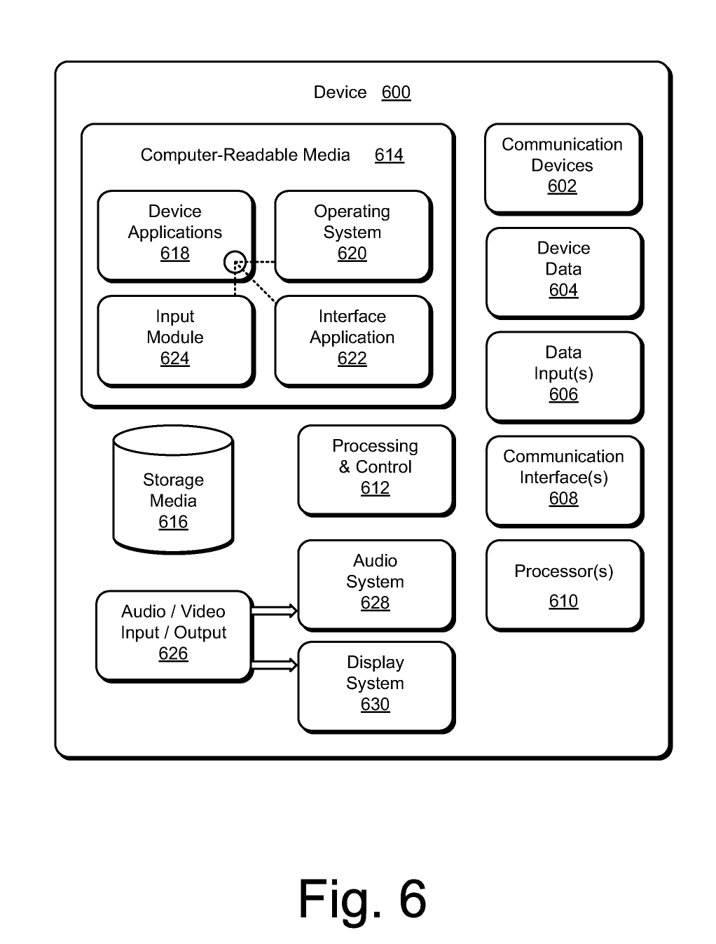

A variety of different types of gestures may be recognized, such a gestures that are recognized from a single type of input (e.g., touch gestures) as well as gestures involving multiple types of inputs. For example, the computing device 102 may be configured to detect and differentiate between a touch input (e.g., provided by one or more fingers of the user's hand 108) and a stylus input (e.g., provided by a stylus 110). The differentiation may be performed in a variety of ways, such as by detecting an amount of the display device 108 that is contacted by the finger of the user's hand 108 versus an amount of the display device 106 that is contacted by the stylus 110. Differentiation may also be performed through use of a camera to distinguish a touch input (e.g., holding up one or more fingers) from a stylus input (e.g., holding two fingers together to indicate a point) in a natural user interface (NUI). A variety of other example techniques for distinguishing touch and stylus inputs are contemplated, further discussion of which may be found in relation to FIG. 6.

Thus, the input module 104 may support a variety of different gesture techniques by recognizing and leveraging a division between stylus and touch inputs. For instance, the input module 104 may be configured to recognize the stylus as a writing tool, whereas touch is employed to manipulate objects displayed by the display device 108. Consequently, the combination of touch and stylus inputs may serve as a basis to indicate a variety of different gestures. For instance, primitives of touch (e.g., tap, hold, two-finger hold, grab, cross, pinch, hand or finger postures, and so on) and stylus (e.g., tap, hold-and-drag-off, drag-into, cross, stroke) may be composed to create a space involving a plurality of gestures. It should be noted that by differentiating between stylus and touch inputs, the number of gestures that are made possible by each of these inputs alone is also increased. For example, although the movements may be the same, different gestures (or different parameters to analogous commands) may be indicated using touch inputs versus stylus inputs.

Additionally, although the following discussion may describe specific examples of touch and stylus inputs, in instances the types of inputs may be switched (e.g., touch may be used to replace stylus and vice versa) and even removed (e.g., both inputs may be provided using touch or a stylus) without departing from the spirit and scope thereof. Further, although in instances in the following discussion the gestures are illustrated as being input using touchscreen functionality, the gestures may be input using a variety of different techniques by a variety of different devices.

The computing device 102 is further illustrated as including a magnification module 112 that is representative of functionality regarding magnification of at least a portion of a user interface. For example, the magnification module 112 may recognize initiation of a magnification gesture detected via touchscreen functionality of the display device 106. Recognition of the magnification gesture may then cause the magnification module 112 to display at least a portion of the user interface as being magnified in relation to other portions of the user interface. Thus, the magnification gesture may enable a user to magnify a portion of the user interface without navigating through menus, calling up functions, and so on, further discussion of which may be found in relation to the following figure.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the magnification gesture techniques described below are platform-independent, meaning that the techniques may be implemented on a variety of commercial computing platforms having a variety of processors.

### Magnification Gesture Implementation Example

FIG. 2 depicts a system 200 in an example implementation in which a magnification gesture is recognized as being initiated to cause display of a portion of a user interface to be magnified. The system 200 of FIG. 2 is illustrated as including first and second stages 202, 204.

At the first stage 202, a user interface having a plurality of images is displayed by the display device 106. The user interface in this example includes representations that are selectable to specify characteristics of inputs to be recognized by the computing device 102. For example, the stylus inputs representation 206 may be selected to specify gestures and other input functionality to be applied in relation to the stylus 110, such as to apply characteristics to inputs as if the stylus 110 was a pencil, pen, marker, crayon, and so on. Likewise, the touch inputs representation 208 may be selected to specify characteristics regarding touch inputs, such as to specify which gestures correspond to which inputs.

At the second stage 204, a magnification gesture is recognized through detection of fingers of a user's hand 108 using touchscreen functionality of the display device 106. Initial points of contact of the fingers of the user's hand 108 are illustrated through the use of circles in the second stage 204. Subsequent movement of the source of the inputs (e.g., the fingers of the user's hand 108) is illustrated through the use of arrows. Thus, the input is recognized as involving selection of two points of the user interface using a touch input in this example and then subsequent movement away from the two points.

Responsive to recognition of the magnification gesture, the magnification module 112 may magnify a portion 210 of the user interface that corresponds to the inputs, e.g., the initial points selected using the fingers of the user's hand 108. The magnification that is applied may be specified in a variety of different ways. For example, an amount of movement involved in the input may serve as a basis for an amount of magnification to be applied to the portion. In another example, the amount of magnification may be predefined such that the movement describes a size of the portion of the user interface that is to be magnified. A variety of other examples are also contemplated.

The portion 210 that is magnified may also be positioned in a variety of ways. For example, the portion 210 may be offset as illustrated such that the portion is not obscured by the user's hand 108 and thus is readily viewable. Thus, in this example the points of contact of the user's hand 108 do not define the area (e.g., the circumference in this example) of the portion 210 directly. However, it should be readily apparent that the portion 210 may also be displayed without an offset without departing from the spirit and scope thereof. The portion 210 of the user interface that is magnified may be leveraged for a variety of different purposes, further discussion of which may be found in relation to the following figure.

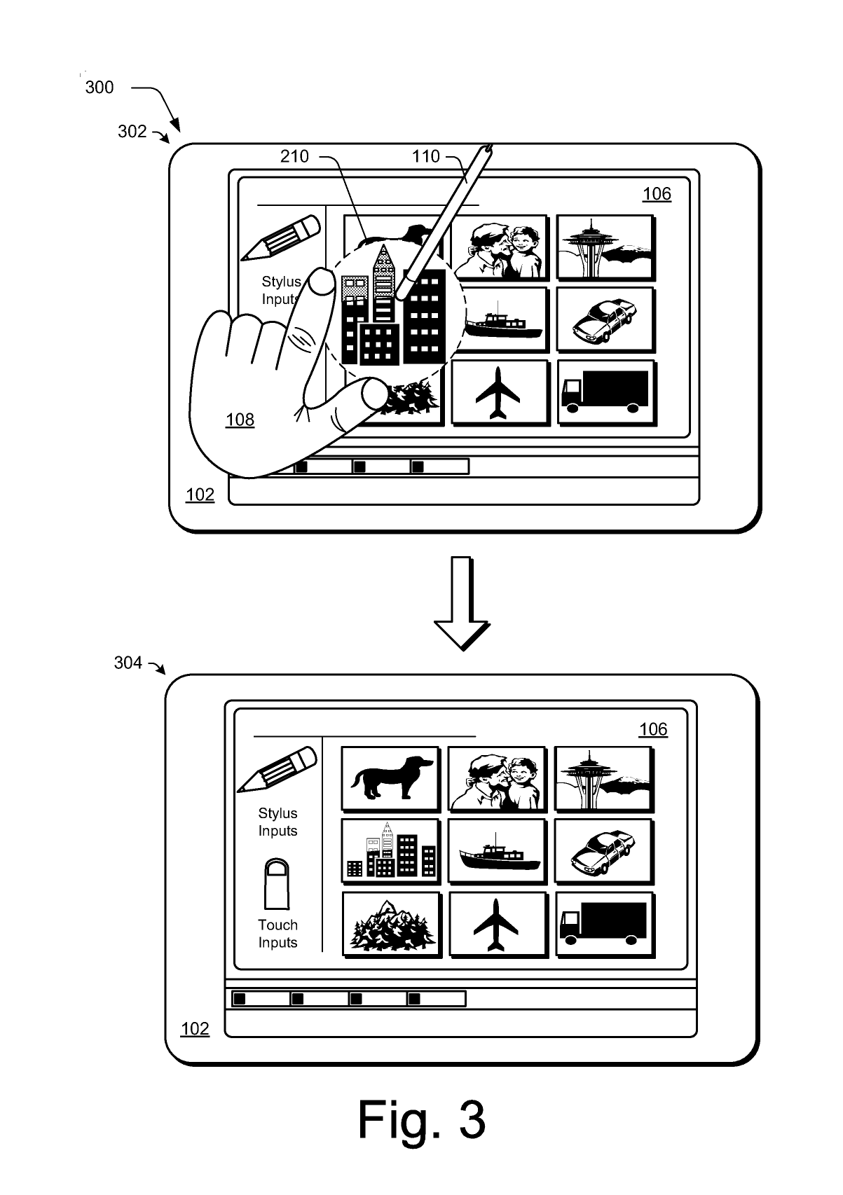

FIG. 3 depicts a system 300 in an example implementation in which the magnification gesture of FIG. 2 is leveraged to modify data that is being magnified. The system 300 of FIG. 3 is also illustrated as including first and second stages 302, 304.

At the first stage 302, the portion 210 that is magnified responsive to the magnification of FIG. 2 is displayed. A stylus 110 is displayed as providing an input to modify data within the portion 210, which is this instance is to lighten the data using an erase operation of the stylus 110. A variety of other operations may be performed to interact with data within the portion 210, such as to view the data, select a portion of a user interface (e.g., a button, a checkbox), receive handwritten inputs from the stylus 110, and so on.

Once the user has finished interaction with data in the portion 210, the user may “let go” to remove the portion as shown in the second stage 304 of FIG. 3. For example, the user may cease contact of the display device 106 with the fingers of the user's hand 108. Accordingly, the magnification module 112 may determine that the magnification gesture has completed and cease the display of the portion 210. In this example, the user interface is then displayed including the modification to the data as shown in the second stage 304. In this example, a portion of the user interface was magnified responsive to a magnification gesture. These technqiues may also be employed responsive to selection of an object, further discussion of which may be found in relation to the following figure.

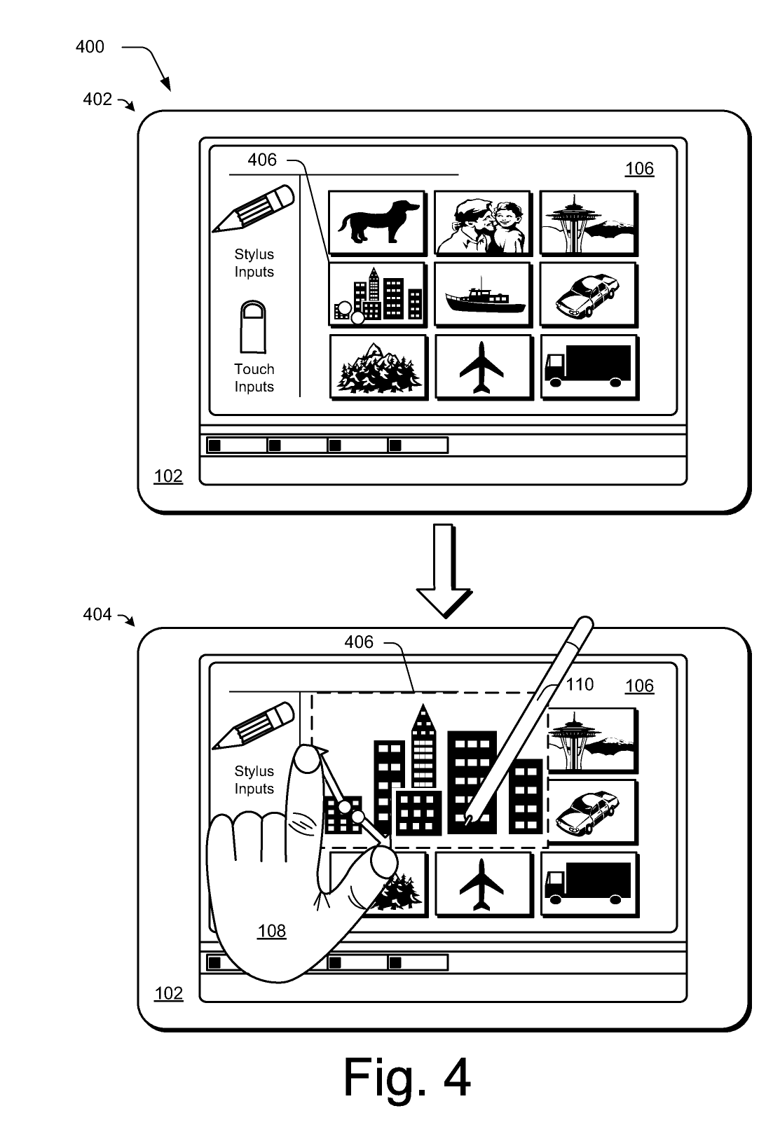

FIG. 4 is an illustration of a system in an example implementation in which an object that is selected via a magnification gesture is magnified. The system 400 of FIG. 4 is also illustrated as including first and second stages 402, 404.

At the first stage 402 the user interface includes a plurality of images as shown before. In this example, however, an image is selected, such as through recognition of two or more touch inputs from the user's hand, which are illustrated using circles an object 406. The magnification module 112 may then recognize from the inputs that the object 406 is selected.

At the second stage 204, a magnification gesture is recognized through the touch inputs selecting the object 406 as described above. The magnification gesture is also recognized from subsequent movement of the source of the inputs (e.g., the fingers of the user's hand 108) is illustrated through the use of arrows. Thus, the input is recognized as involving selection of two points of the user interface as before. However, in this instance this selection is used to select an underlying object 406 in the user interface, e.g., an image in this example although other objects are also contemplated such as folders, controls, icons, and other objects displayable in a graphical user interface.

Responsive to recognition of the magnification gesture, the magnification module 112 may magnify the object 406 of the user interface that corresponds to the inputs, e.g., the object 406 selected using the fingers of the user's hand 108. As before, the magnification that is applied may be specified in a variety of different ways. For example, an amount of movement involved in the input (illustrated as the length of the arrows) may serve as a basis for an amount of magnification to be applied to the portion. In another example, the amount of magnification may be predefined such that the movement describes a size of the portion of the user interface that is to be magnified. A variety of other examples are also contemplated.

The object 406 that is magnified may also be positioned in a variety of ways. For example, the object 406 may be offset as illustrated such that the object 406 is not obscured by the user's hand 108 and thus is readily viewable. An animation, for instance, may be employed that both magnifies and offsets the object 406 responsive to the inputs, e.g., movement of the fingers of the user's hand 108. Thus, the portion that is magnified in the user interface may take a variety of different forms. Further, it should be noted that the shape and size of the portion may also assume a variety of configurations as shown by the circular shape in FIGS. 2 and 3 and the rectangular shape in FIG. 4. Other shapes and sizes are also contemplated.

### Example Procedures

The following discussion describes magnification gesture techniques that may be implemented utilizing the previously described systems and devices. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-400 of FIGS. 2-4.

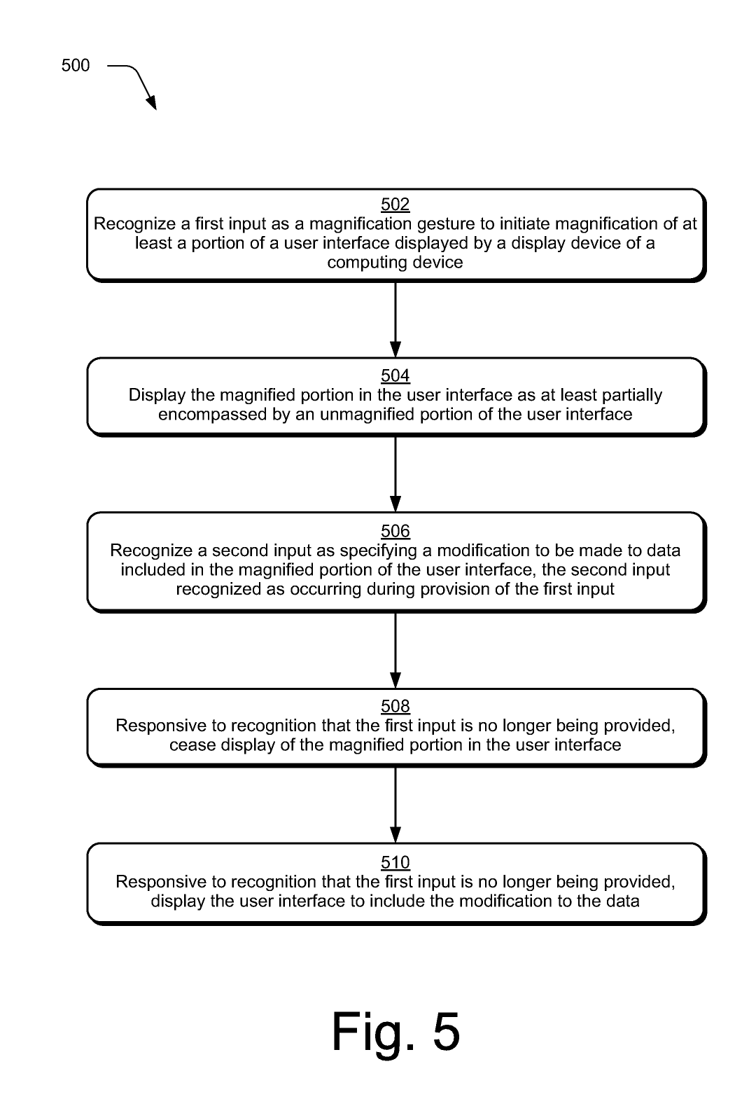

FIG. 5 depicts a procedure 500 in an example implementation in which a magnification gesture is recognized to magnify a portion of a user interface and cease display of the magnification once the gesture is no longer detected. A first input is recognized as a magnification gesture to initiate magnification of at least a portion of a user interface displayed by a display device of a computing device (block 502). The first input, for instance, may involve placing two fingers of the user's hand 108 on the display device 108 and then moving the fingers away from each other. Other inputs are also contemplated, such as selection of an object using the touch inputs as described in FIG. 4, selection of an object using a stylus 110, and so on.

The magnified portion is displayed in the user interface as at least partially encompassed by an unmagnified portion of the user interface (block 504). As shown in FIG. 2, for instance, the portion 210 is surrounded by unmagnified portions of the user interface. Further, the display of the magnified portion may be offset so as not to be obscured by a source of the input, e.g., finger's of the user's hand 108, the stylus 110, and so on.

A second input is recognized as specifying a modification to be made to data included in the magnified portion of the user interface, the second input recognized as occurring during provision of the first input (block 506). The second input, for instance, may involve checking a box in the user interface, inputting one or more characters, drawing a line, erasing a line, and so on.

Responsive to the recognition that the first input is no longer being provided, display of the magnified portion in the user interface ceases (block 508). Continuing with the previous example, the fingers of the user's hand 108 may be moved away from the display device 106. This may be detected by the magnification module 112 as completion of the magnification gesture and thus cease display of the portion 210. Thus, responsive to recognition that the first input is not longer being provided the user interface is displayed to include the modification to the data (block 510), such as to show the lightened section of the image as shown in the second stage 304 of FIG. 3. A variety of other examples are also contemplated, such as implement an action as a result of a user's interaction with a magnification portion, e.g., to implement an action caused through selection of a button, save data, and so on.

### Example Device

FIG. 6 illustrates various components of an example device 600 that can be implemented as any type of portable and/or computer device as described with reference to FIGS. 1 through 4 to implement embodiments of the gesture techniques described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more o\f a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of a touch pull-in gesture. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.). The device applications 618 also include any system components or modules to implement embodiments of the gesture techniques described herein. In this example, the device applications 618 include an interface application 622 and an input module 624 (which may be the same or different as input module 114) that are shown as software modules and/or computer applications. The input module 624 is representative of software that is used to provide an interface with a device configured to capture inputs, such as a touchscreen, track pad, camera, and so on. Alternatively or in addition, the interface application 622 and the input module 624 can be implemented as hardware, software, firmware, or any combination thereof. Additionally, the input module 624 may be configured to support multiple input devices, such as separate devices to capture touch and stylus inputs, respectively. For example, the device may be configured to include dual display devices, in which one of the display device is configured to capture touch inputs while the other stylus inputs.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
recognizing a first input as a magnification gesture to initiate magnification of at least a portion of a user interface displayed by a display device of a computing device;
displaying the magnified portion in the user interface as at least partially encompassed by an unmagnified portion of the user interface;
recognizing a second input as specifying a modification to be made to data included in the magnified portion of the user interface, the second input recognized as occurring during provision of the first input; and
responsive to recognition that the first input is no longer being provided, ceasing the displaying of the magnified portion in the user interface.

2. A method as described in claim 1, wherein the first input is recognized as selecting two points of the user interface.

3. A method as described in claim 1, wherein the first input is recognized as selecting an object in the user interface and the displaying of the magnified portion includes display of the object as being magnified.

4. A method as described in claim 1, wherein the first input is recognized as a touch input and the second input is recognized as a stylus input.

5. A method as described in claim 1, wherein the displaying of the magnified portion includes offsetting the magnified portion so as not to be obscured by a source of the first input.

6. A method as described in claim 5, wherein the source of the first input is one or more fingers or a stylus.

7. A method as described in claim 1, wherein the first input is recognized as movement across a distance in the user interface and the portion of the user interface is magnified as corresponding to the distance.

8. A method as described in claim 1, wherein the first input is recognized as:
selecting two points in the user interface; and
involving subsequent movement of a respective source of the inputs away from the two points and across the user interface of the display device.

9. A method as described in claim 1, wherein the first input is recognized using a camera

10. A method as described in claim 1, further comprising saving the modification to the data in a computer-readable memory.

11. A method as described in claim 1, further comprising responsive to recognition that the first input is no longer being provided, displaying the user interface to include the modification to the data.

12. A method comprising:
recognizing a first input as selecting two points in a user interface displayed by a display device of a computing device and involving subsequent movement away from the two points;
identifying a magnification gesture from the recognized first input, the magnification gesture effective to cause a magnified display of at least a portion of the user interface that corresponds to the selected two points, the magnified display at least partially encompassed by an unmagnified portion of the user interface; and
recognizing a second input as specifying interaction with data included in the magnified portion of the user interface, the second input recognized as provided during provision of the first input.

13. A method as described in claim 12, wherein:
the first input is one of a touch input or a stylus input; and
the second input is the other of the touch input or the stylus input.

14. A method as described in claim 12, wherein the magnified display of the portion is offset so as not to be obscured by at least one said source of the first input.

15. A method as described in claim 12, wherein the first input is recognized as a touch input and the second input is recognized as a stylus input.

16. A method as described in claim 12, further comprising responsive to recognition that the first input is no longer being provided, ceasing display of the magnified portion in the user interface.

17. A method as described in claim 12, further comprising responsive to recognition that the first input is no longer being provided, displaying the user interface to include a result of the interaction with the data.

18. One or more computer-readable media comprising instructions stored thereon that, responsive to execution on a computing device, causes the computing device to perform operations comprising:
recognizing a touch input as a magnification gesture to indicate magnification of at least a portion of a user interface displayed by a display device of a computing device;
displaying the magnified portion in the user interface as at least partially encompassed by an unmagnified portion of the user interface;
recognizing a stylus input as specifying a modification to be made to data included in the magnified portion, the stylus input recognized as being provided during provision of the touch input; and
responsive to recognition that the first input is no longer being provided, ceasing the displaying of the magnified portion in the user interface.

19. One or more computer-readable media as described in claim 18, wherein the magnified display of the portion is offset so as not to be obscured by a source of the touch input.

20. One or more computer-readable media as described in claim 18, further comprising responsive to recognition that the first input is no longer being provided, displaying the user interface to include the modification to the data.
